(19) United States
(12) Patent Application Publication
(10) Pub. No.: US 2014/0154976 A1
(43) Pub. Date: Jun. 5, 2014

(54) SYSTEMS AND METHODS FOR COMMUNICATING BETWEEN INFORMATION HANDLING SYSTEMS USING SHORT-RANGE WIRELESS COMMUNICATION

(71) Applicant: DELL PRODUCTS L.P., Round Rock, TX (US)

(72) Inventors: Kevin D. Terwilliger, Austin, TX (US); Orin M. Ozias, Austin, TX (US); Scott C. Lauffer, Austin, TX (US)

(73) Assignee: Dell Products L.P., Round Rock, TX (US)

(21) Appl. No.: 13/692,448

(22) Filed: Dec. 3, 2012

(51) Int. Cl. H04W 4/00

(52) U.S. Cl. CPC H04W 4/008
USPC 455/41.1; 455/41.2

(57) ABSTRACT

In accordance with embodiments of the present disclosure, a drawer may include an antenna, one or more structural elements, and one or more electrical components. The antenna may be configured to transmit via a short-range wireless communication technology. The one or more structural elements may be configured to permit the drawer to translate between an open position and a closed position relative to a chassis mechanically coupled to the drawer. The one or more electrical components may configured to enable the antenna for wireless communication via the short-range wireless communication technology when the drawer is in the open position and disable the antenna for wireless communication via the short-range wireless communication technology when the drawer is in the closed position.

### TECHNICAL FIELD

The present disclosure relates to information handling systems. More specifically, embodiments of the disclosure provide systems and methods for facilitating communication between information handling systems using short-range wireless communication.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Oftentimes, information handling systems are manufactured in a modular form factor and may be configured to be disposed in a chassis configured to receive such modular information handling systems. In many data center installations, multiple chasses each comprising multiple information handling systems may be present. For such a data center to operate efficiently, information technology administrators may desire to occasionally check one or more operational parameters of an information handling system. Traditionally, such information is often displayed by each information handling system or chassis via a display device (e.g., a liquid crystal display) integral to the individual information handling systems or integral to the individual chasses. However, one disadvantage to these traditional approaches are the manufacturing costs associated with including a liquid crystal display integral to each information handling system or chassis.

### SUMMARY

In accordance with the teachings of the present disclosure, the disadvantages and problems associated with traditional approaches to managing information handling systems have been eliminated or reduced.

In accordance with embodiments of the present disclosure, a drawer may include an antenna, one or more structural elements, and one or more electrical components. The antenna may be configured to transmit via a short-range wireless communication technology. The one or more structural elements may be configured to permit the drawer to translate between an open position and a closed position relative to a chassis mechanically coupled to the drawer. The one or more electrical components may configured to enable the antenna for wireless communication via the short-range wireless communication technology when the drawer is in the open position and disable the antenna for wireless communication via the short-range wireless communication technology when the drawer is in the closed position.

In accordance with these and other embodiments of the present disclosure, a chassis may include a plurality of modular information handling systems and at least one antenna drawer. The at least one antenna drawer may associated with one of the plurality of modular information handling systems and may be configured to translate between an open position and a closed position relative to the chassis. The at least one antenna drawer may include an antenna and one or more electrical components. The antenna may be configured to transmit via a short-range wireless communication technology. The one or more electrical components may be configured to enable the antenna for wireless communication via the short-range wireless communication technology when the antenna drawer is in the open position and disable the antenna for wireless communication via the short-range wireless communication technology when the antenna drawer is in the closed position.

In accordance with these and other embodiments of the present disclosure, a method may include enabling an antenna for wireless communication via a short-range communication technology responsive to translation of a drawer comprising the antenna from a closed position to an open position relative to a chassis mechanically coupled to the drawer. The method may further include transmitting a shared secret via the short-range wireless communication technology while the antenna is enabled, wherein the shared secret may be used by a mobile information handling system receiving the shared secret to authenticate for wireless communication between the mobile information handling system and an information handling system associated with the antenna.

Technical advantages of the present disclosure may be apparent to those of ordinary skill in the art in view of the following specification, claims, and drawings.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a system for communicating between information handling systems using short-range wireless communications, in accordance with embodiments of the present disclosure;

FIG. 2 illustrates a perspective view of selected components of an antenna drawer associated with an information handling system of the chassis depicted in FIG. 1, in accordance with embodiments of the present disclosure;

FIG. 3 illustrates a side elevation view of selected components of an antenna drawer associated with an information handling system of the chassis depicted in FIG. 1, in accordance with embodiments of the present disclosure; and

FIG. 4 illustrates a flow chart of an example method for communicating between information handling systems using short-range wireless communications, in accordance with embodiments of the present disclosure.

### DETAILED DESCRIPTION

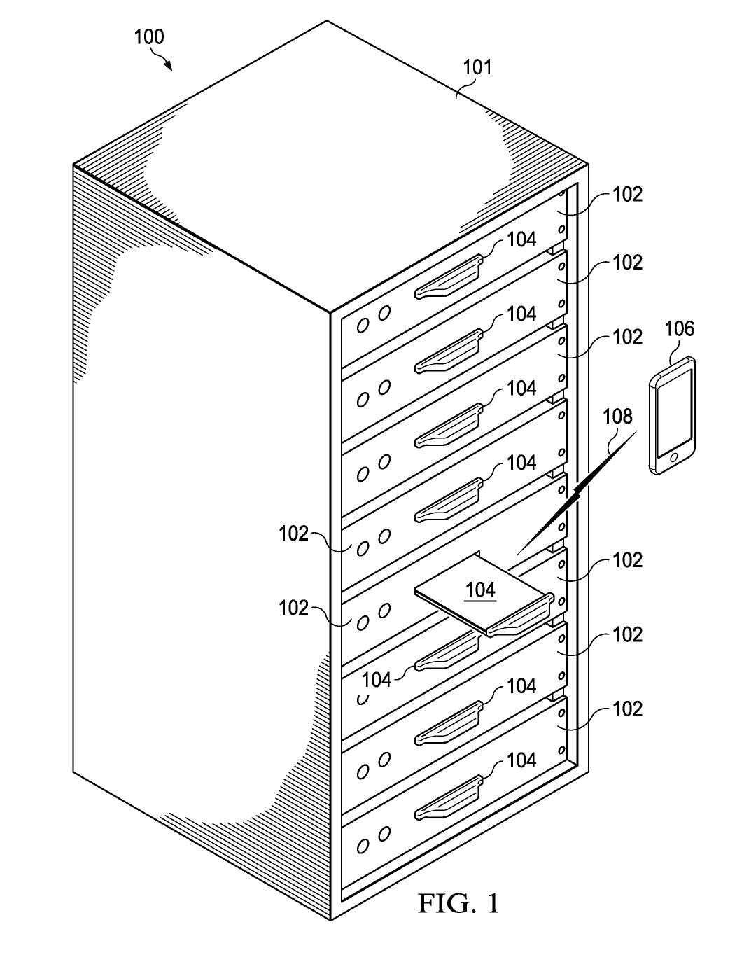

Preferred embodiments and their advantages are best understood by reference to FIGS. 1-4, wherein like numbers are used to indicate like and corresponding parts.

For the purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (CPU) or hardware or software control logic. Additional components of the information handling system may include one or more storage devices, one or more communications ports for communicating with external devices as well as various input and output (I/O) devices, such as a keyboard, a mouse, and a video display. The information handling system may also include one or more busses operable to transmit communication between the various hardware components. For the purposes of this disclosure, computer-readable media may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; as well as communications media such as wires, optical fibers, microwaves, radio waves, and other electromagnetic and/or optical carriers; and/or any combination of the foregoing.

For the purposes of this disclosure, information handling resources may broadly refer to any component system, device or apparatus of an information handling system, including without limitation processors, busses, memories, input-output devices and/or interfaces, storage resources, network interfaces, motherboards, electro-mechanical devices (e.g., fans), displays, and power supplies.

For the purposes of this disclosure, the terms “wireless transmissions” and “wireless communication” may be used to refer to all types of electromagnetic communications which do not require a wire, cable, or other types of conduits. Examples of wireless transmissions which may be used include, but are not limited to, short-range wireless communication technologies (e.g., proximity card, Radio-Frequency Identification (RFID), Near Field Communication (NFC), BLUETOOTH, ISO 14443, ISO 15693, or other suitable standard), personal area networks (PAN) (e.g., BLUETOOTH), local area networks (LAN), wide area networks (WAN), narrowband personal communications services (PCS), broadband PCS, circuit switched cellular, cellular digital packet data (CDPD), radio frequencies, such as the 800 MHz, 900 MHz, 1.9 GHz and 2.4 GHz bands, infra-red and laser.

For the purpose of this disclosure, “short-range wireless communications technology” refers to any suitable communications transport, protocol, and/or standard allowing two or more suitably-configured devices to communicate via wireless transmissions provided that such devices are within approximately one meter of each other. Examples of short-range communications technologies include, without limitation, BLUETOOTH Class 3, NFC, RFID, proximity card, vicinity card, ISO 14443, and ISO 15693.

FIG. 1 illustrates a system 100 for communicating between information handling systems using short-range wireless communications, in accordance with embodiments of the present disclosure. As shown in FIG. 1, system 100 may include a chassis 101 for receiving a plurality of modular information handling systems 102 and a mobile information handling system 106. Chassis 101 may be an enclosure that serves as a container for various information handling systems 102 and information handling resources, and may be constructed from steel, aluminum, plastic, and/or any other suitable material. Although the term “chassis” is used, chassis 101 may also be referred to as a case, cabinet, tower, box, enclosure, and/or housing. Chassis 101 may be configured to hold and/or provide power to information handling systems 102 and/or other information handling resources.

An information handling system 102 may generally be operable to receive data from and/or communicate data to one or more other information handling systems 102 and/or information handling resources of chassis 101. In certain embodiments, an information handling system 102 may be a server. In such embodiments, an information handling system may comprise a blade server having modular physical design. In these and other embodiments, an information handling system 102 may comprise an M class server.

As described in greater detail below, an information handling system 102 may be configured to communicate via wireless transmissions 108 with a mobile information handling system 106. Mobile information handling system 106 may comprise any mobile computing device intended to be readily portable by its intended user and may include a laptop computer, tablet computer, PDA, smartphone, or other suitable device.

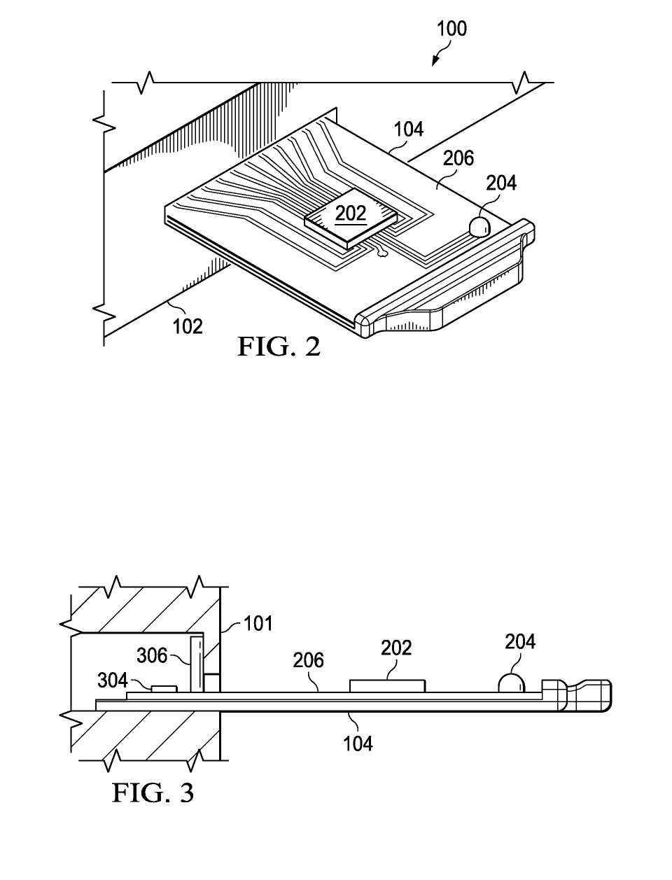

As shown in FIG. 1 and described in greater detail with respect to FIGS. 2 and 3, each information handling system 102 may have an antenna drawer 104 for translating an antenna 202 between an open position (in which antenna 202 is physically external to chassis 101) and a closed position (in which antenna 202 is physically internal to chassis 101). Accordingly, although not depicted in the FIGURES, an antenna drawer 104, its associated information handling system 102, and/or chassis 101 may include a combination of rails, bearings, handles, and/or other mechanical components for allowing a user to apply an appropriate mechanical force to translate antenna drawer 104 between the open position and the closed position, and vice versa.

FIG. 2 illustrates a perspective view and FIG. 3 illustrates a side elevation view of selected components of an antenna drawer 104 associated with an information handling system 102 of the chassis 101, in accordance with embodiments of the present disclosure. As shown in FIGS. 2 and 3, an antenna drawer 104 may comprise a short-range wireless communications antenna 202 communicatively coupled (e.g., via electrically-conductive materials) to its associated information handling systems 102. A short-range wireless communications antenna 202 may comprise any suitable antenna for communicating via wireless transmissions between its associated information handling system 102 and another device (e.g., mobile information handling system 106) using one or more short-range wireless communications technologies.

In some embodiments, an antenna drawer 104 may also include a visual indicator 204. Visual indictor 204 may include any suitable indicator (e.g., a light-emitted diode or other light source) configured to provide a human-perceptible visual indication.

In these and other embodiments, antenna drawer 104 may comprise a printed circuit board 206 to which short-range wireless communications antenna 202 and/or visual indicator 204 may be mounted, in order to provide electrical power to short-range wireless communications antenna 202 and/or visual indicator 204 and/or to provide communicative coupling (e.g., via electrically-conductive traces present on printed circuit board 206) between an information handling resource 102 and its associated short-range wireless communications antenna 202 and/or visual indicator 204.

In some embodiments of the present disclosure, an antenna drawer 104 and its various components may be configured such that antenna 202 is able to transmit a wireless signal when antenna drawer 104 is in an open position, but disabled from transmitting a wireless signal when antenna drawer 104 is closed. In some embodiments, antenna 202 may be enabled to transmit a wireless signal only when antenna drawer 104 is at or near its fully-opened position. In these and other embodiments, antenna drawer 104 and its various components may be configured such that visual indicator 204 gives a visual indication (e.g., illuminates) when antenna 202 is enabled to wirelessly transmit signals. Although such functionality of antenna 202 and/or visual indicator 204 may be accomplished in any suitable manner, in some embodiments such functionality may be accomplished as illustrated in FIG. 3.

As shown in FIG. 3, antenna drawer 104 may comprise a conductive pad 304 electrically coupled to antenna 202 and/or visual indicator 204. The information handling system 102 associated with antenna drawer 104 may have electrically coupled thereto a conductive pin 306, such that when antenna drawer 104 is in an open position, conductive pad 304 and conductive pin 306 come in contact to complete an electrical circuit. In some embodiments, such electrical circuit may be a supply of power to antenna 202 and/or visual indicator 204, such that power is supplied to antenna 202 and/or visual indicator 204 when antenna drawer 104 is in an open position, and power is withdrawn from antenna 202 and/or visual indicator 204 when antenna drawer 104 is in a closed open position.

In these and other embodiments, translation of antenna drawer 104 into an open position may also enable other wireless communication capabilities of information handling system 102. For example, in such embodiments, translation of antenna drawer 104 into an open position may enable near-field communication transmission of antenna 202 and also enable BLUETOOTH communication transmission of information handling system 102. In such embodiments, translation of antenna drawer 104 into a closed position may also disable other wireless communication capabilities of information handling system 102. For example, in such embodiments, translation of antenna drawer 104 into a closed position may disable near-field communication transmission of antenna 202 and also disable BLUETOOTH communication transmission of information handling system 102.

Accordingly, a user can enable and disable transmission of antenna 202 by opening and closing antenna drawer 104 as desired, and thus, may choose an information handling system 102 to wirelessly communicate with mobile information handling system 106 by selecting the desired information handling system 102 and translating its associated antenna drawer 104 to an open position, thus enabling antenna 202 and/or other wireless communication capabilities of information handling system 102. In addition, drawer 104 and/or visual indicator 204 may each give a visual indication to a user regarding whether an antenna 202 is transmitting. For example, a drawer 104, simply by being in an open position, may indicate to a user that an antenna 202 is transmitting a signal. Similarly, an illuminated visual indicator 204 may also indicate to a user that an antenna 202 is transmitting a signal.

In FIGS. 1-3 described above, an antenna drawer 104 has been described as a structural element that engages with a chassis 101 in such a way that it can be drawn out and pushed in in a generally linear fashion. However, as used herein, an antenna drawer 104 is intended to include any suitable structural component interfacing with a chassis that may be drawn out from such chassis to allow access to components of such antenna drawer 104. For example, in some embodiments, antenna drawer 104 may be coupled to chassis 101 via one end of antenna drawer 104 such that it rotates about an axis of the hinge relative to the chassis.

In operation, antenna 202 may, when enabled for transmission responsive to antenna drawer 104 being drawn into an open position, transmit a shared secret (e.g., a random number, a symmetric key, asymmetric private/private key pair, a passcode, a unique identifier and/or other suitable secret) via a short-range wireless communication technology. In some embodiments, the short-range wireless communication technology used to transmit the shared secret from antenna 202 may comprise near-field communication. A mobile device 106 sufficiently proximate to antenna 202 may receive the shared secret and likewise transmit the shared secret via a wireless communication technology (e.g., the same wireless communication technology by which antenna 202 transmits the shared secret, or another wireless communication technology) to information handling system 102 (e.g., to a processor, service processor, remote access controller, or other suitable component of the information handling system 102), thus authenticating mobile device 106 for wireless communication with the information handling system 102. Once authentication has occurred, information handling system 102 and mobile information handling system 106 may communicate information between each other. For example, information handling system 102 may communicate identifying information (e.g., serial number, service tag number, model number, etc.) and/or operational parameters (e.g., operational errors, operational conditions, etc.). In some embodiments, the wireless communication technology used to transmit between mobile information handling system 106 and information handling system 102 may comprise BLUETOOTH.

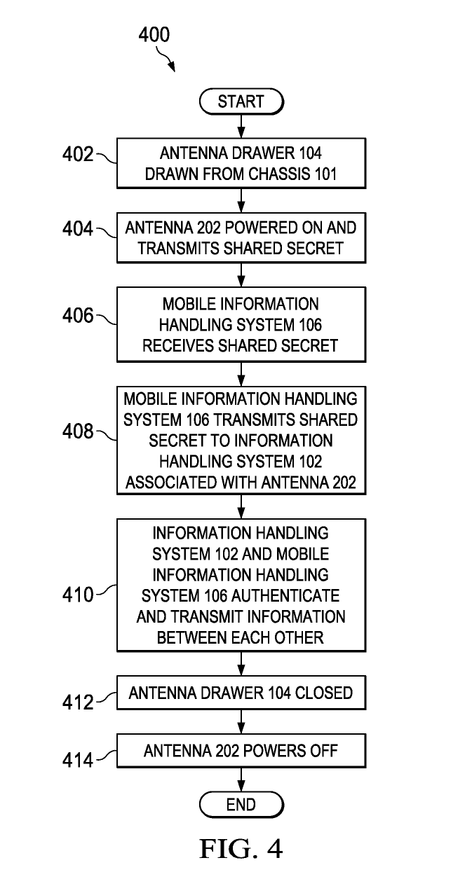

FIG. 4 illustrates a flow chart of an example method 400 for communicating between information handling systems using short-range wireless communications, in accordance with embodiments of the present disclosure. According to one embodiment, method 400 may begin at step 402. As noted above, teachings of the present disclosure may be implemented in a variety of configurations of system 100. As such, the preferred initialization point for method 400 and the order of the steps 402-414 comprising method 400 may depend on the implementation chosen.

In step 402, an antenna drawer 104 may be drawn from chassis 101 into an open position (e.g., by a user applying an appropriate outward force on antenna drawer 104) such that antenna 202 associated with antenna drawer 104 is located outside of chassis 101. In step 404, responsive to antenna drawer 104 being drawn into the open position, antenna 202 may be enabled for transmission and may transmit a shared secret via a short-range wireless communication technology. In some embodiments, the short-range wireless communication technology used to transmit the shared secret from antenna 202 may comprise near-field communication. In these and other embodiments, translation of antenna drawer 104 into an open position may also enable other wireless communication capabilities of information handling system 102. For example, in such embodiments, translation of antenna drawer 104 into an open position may enable near-field communication transmission of antenna 202 and also enable BLUETOOTH communication transmission of information handling system 102.

In step 406, mobile information handling system 106 (e.g., carried by the user that opened antenna drawer 104) may receive the shared secret transmitted by antenna 202. In step 408, responsive to receiving the shared secret, mobile information handling system 106 may transmit the shared secret to an information handling system 102 associated with antenna 202. In step 410, information handling system 102 and mobile information handling system 106 may authenticate wireless communication with each other (e.g., wireless communication via a short-range wireless communication technology) based on the shared secret and begin transmitting information between each other via wireless transmissions 108. In some embodiments, the wireless communication technology used to communicate between mobile information handling system 102 and mobile information handling system 106 may comprise BLUETOOTH.

At step 412, antenna drawer 104 may be closed into a closed position (e.g., by a user applying an appropriate inward force on antenna drawer 104) such that antenna 202 associated with antenna drawer 104 is located inside of chassis 101. In step 414, responsive to antenna drawer 104 being translated to the closed position, antenna 202 may be disabled from transmitting. In these and other embodiments, translation of antenna drawer 104 into a closed position may also disable other wireless communication capabilities of information handling system 102. For example, in such embodiments, translation of antenna drawer 104 into a closed position may disable near-field communication transmission of antenna 202 and also disable BLUETOOTH communication transmission of information handling system 102.

Although FIG. 4 discloses a particular number of steps to be taken with respect to method 400, method 400 may be executed with greater or lesser steps than those depicted in FIG. 4. In addition, although FIG. 4 discloses a certain order of steps to be taken with respect to method 400, the steps comprising method 400 may be completed in any suitable order.

Method 400 may be implemented using information handling system 100 or any other system operable to implement method 400. In certain embodiments, method 400 may be implemented partially or fully in software and/or firmware embodied in computer-readable media.

The methods and systems described herein may provide one or more advantages over traditional approaches. By embedding antenna 202 into antenna drawer 104, access to antenna 202 may be provided without taking up significant space on chassis 101. In addition, by acting as a switch for enabling and disabling wireless communication capabilities of an information handling system 102, antenna drawer 104 may provide a desired level of communications security. Such antenna drawer 104 and, if present, visual indicator 204 may provide an additional layer of security by providing a user with a human-perceptible indication of whether information handling system 102 is transmitting a wireless communication signal.

Although the present disclosure has been described in detail, it should be understood that various changes, substitutions, and alterations can be made hereto without departing from the spirit and the scope of the disclosure as defined by the appended claims.

What is claimed is:

1. A drawer, comprising:
an antenna configured to transmit via a short-range wireless communication technology;
one or more structural elements configured to permit the drawer to translate between an open position and a closed position relative to a chassis mechanically coupled to the drawer; and
one or more electrical components configured to enable the antenna for wireless communication via the short-range wireless communication technology when the drawer is in the open position and disable the antenna for wireless communication via the short-range wireless communication technology when the drawer is in the closed position.

2. The drawer of claim 1, the one or more electrical components configured to enable an information handling system associated with the antenna for wireless communication when the drawer is in the open position and disable the information handling system for wireless communication when the drawer is in the closed position.

3. The drawer of claim 2, wherein, when enabled for wireless communication, the information handling system transmits information via the short-range wireless communication.

4. The drawer of claim 2, wherein, when enabled for wireless communication, the information handling system transmits information via a second short-range wireless communication different from the short-range wireless technology.

5. The drawer of claim 2, wherein, when enabled for wireless communication, the information handling system transmits information via BLUETOOTH.

6. The drawer of claim 1, the antenna configured to, when enabled for wireless communication, transmit a shared secret, wherein the shared secret may be used by a mobile information handling system receiving the shared secret to authenticate for wireless communication between the mobile information handling system and an information handling system associated with the antenna.

7. The drawer of claim 1, further comprising a visual indicator configured to generate a human-perceptible indication when the antenna is enabled for wireless communication.

8. The drawer of claim 1, wherein the short-range wireless communication technology comprises BLUETOOTH.

9. A chassis, comprising:
a plurality of modular information handling systems;
at least one antenna drawer associated with one of the plurality of modular information handling systems, the at least one antenna drawer configured to translate between an open position and a closed position relative to the chassis, the at least one antenna drawer comprising:
an antenna configured to transmit via a short-range wireless communication technology; and
one or more electrical components configured to enable the antenna for wireless communication via the short-range wireless communication technology when the antenna drawer is in the open position and disable the antenna for wireless communication via the short-range wireless communication technology when the antenna drawer is in the closed position.

10. The chassis of claim 9, the one or more electrical components configured to enable the information handling system associated with the antenna drawer for wireless communication when the antenna drawer is in the open position and disable the information handling system for wireless communication when the antenna drawer is in the closed position.

11. The chassis of claim 10, wherein, when enabled for wireless communication, the information handling system associated with the antenna drawer transmits information via the short-range wireless communication.

12. The chassis of claim 10, wherein, when enabled for wireless communication, the information handling system associated with the antenna drawer transmits information via a second short-range wireless communication different from the short-range wireless technology.

13. The chassis of claim 10, wherein, when enabled for wireless communication, the information handling system associated with the antenna drawer transmits information via BLUETOOTH.

14. The chassis of claim 9, the antenna configured to, when enabled for wireless communication, transmit a shared secret, wherein the shared secret may be used by a mobile information handling system receiving the shared secret to authenticate for wireless communication between the mobile information handling system and the information handling system associated with the antenna drawer.

15. The chassis of claim 9, the antenna drawer further comprising a visual indicator configured to generate a human-perceptible indication when the antenna is enabled for wireless communication.

16. The chassis of claim 9, wherein the short-range wireless communication technology comprises BLUETOOTH.

17. A method comprising:
enabling an antenna for wireless communication via a short-range communication technology responsive to translation of a drawer comprising the antenna from a closed position to an open position relative to a chassis mechanically coupled to the drawer; and
transmitting a shared secret via the short-range wireless communication technology while the antenna is enabled, wherein the shared secret may be used by a mobile information handling system receiving the shared secret to authenticate for wireless communication between the mobile information handling system and an information handling system associated with the antenna.

18. The method of claim 17, further comprising disabling the antenna for wireless communication responsive to translation of the drawer to the closed position.

19. The method of claim 17, the short-range wireless communication technology comprising near-field communication.

20. The method of claim 17, further comprising enabling an information handling system associated with the antenna for wireless communication responsive to translation of the drawer to the open position.
